(19) United States
(12) Patent Application Publication
(10) Pub. No.: US 2020/0012971 A1
(43) Pub. Date: Jan. 9, 2020

(54) SYSTEMS AND METHODS FOR DYNAMIC TRANSFER-BASED TRANSPORTATION

(71) Applicant: Lyft, Inc., San Francisco, CA (US)

(72) Inventors: David Chouinard, San Francisco, CA (US); Mayank Gulati, San Francisco, CA (US); Erbil Karaman, Berkeley, CA (US); Dor Levi, San Francisco, CA (US); Garrett van Ryzin, Brooklyn, NY (US)

(21) Appl. No.: 16/028,489

(22) Filed: Jul. 6, 2018

(51) Int. Cl. G06Q 10/02; G06Q 20/08

(52) U.S. Cl. CPC G06Q 10/02; G06Q 2240/00; G06Q 20/08

(57) ABSTRACT

The disclosed computer-implemented method may include matching transportation requests (e.g., made to a dynamic transportation matching system) to one or more transportation providers via transfer points. Matching one or more transportation requestors to a single transportation provider may lead to inefficiencies. By matching transportation requestors with one or more transportation providers via transfer points, a dynamic transportation matching system may increase the efficiency of trips for both transportation providers and transportation requestors. The method may also allocate transportation resources more efficiently across different regions, areas, and/or types of transit areas. In addition, the method may efficiently distribute transportation requestors across different transit options throughout a region to minimize congestion, to minimize over-usage of some constrained transit options, and/or to minimize travel time of transportation providers and/or transportation requestors throughout the region. Various other methods, systems, and computer-readable media are also disclosed.

### BACKGROUND

Some transportation services may provide transportation on demand, drawing from a transportation resources to meet the needs of those requesting transportation as the needs arise. In many examples, dynamic transportation matching service may attempt to provide a transportation requestor with a route to their destination that is efficient in terms of time, cost, or other constraints for both the transportation requestor and the dynamic transportation network. In some cases, requests from multiple transportation requestors may have either overlapping start points or overlapping destinations, but not both overlapping start points and destinations. In other cases, transportation requestors may be limited by the constraints of transportation providers in the area, such as transportation providers that request not to leave a certain service area or transportation providers that request to travel in a certain direction. Various different situations may pose challenges to dynamic transportation matching systems in terms of satisfying the constraints of transportation requestors and transportation providers while enabling transportation requestors to make decisions of about trade-offs of time, cost, and/or comfort. Accordingly, increasing the flexibility of dynamic transportation matching systems may enable dynamic transportation matching systems to provide a better experience to both transportation requestors and transportation providers.

### BRIEF DESCRIPTION OF THE DRAWINGS

The accompanying drawings illustrate a number of exemplary embodiments and are a part of the specification. Together with the following description, these drawings demonstrate and explain various principles of the instant disclosure.

FIG. 1 is an illustration of an example set of trips via a dynamic transportation network.

FIG. 2 is an illustration of an example system for dynamic transfer-based transportation.

FIG. 3 is an illustration of an example system for dynamic transfer-based transportation.

FIG. 4 is an illustration of an example set of trips via a dynamic transportation network.

FIG. 5 is an illustration of an example set of trips via a dynamic transportation network.

FIG. 6 is an illustration of an example transportation bottleneck.

FIG. 7 is an illustration of an example set of transfer points for a dynamic transportation network.

FIG. 8 is an illustration of an example set of trips via a dynamic transportation network.

FIG. 9 is an illustration of an example set of trips via a dynamic transportation network.

FIG. 10 is a flow diagram of an example method for dynamic transfer-based transportation.

FIG. 11 is a flow diagram of an additional example method for dynamic transfer-based transportation.

FIG. 12 is an illustration of an example requestor/provider management environment.

FIG. 13 is an illustration of an example data collection and application management system.

Throughout the drawings, identical reference characters and descriptions indicate similar, but not necessarily identical, elements. While the exemplary embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the instant disclosure covers all modifications, equivalents, and alternatives falling within the scope of the appended claims.

### DETAILED DESCRIPTION OF EXEMPLARY EMBODIMENTS

The present disclosure is generally directed to matching transportation requests (e.g., to a dynamic transportation matching system) to one or more transportation providers via transfer points. Matching one or more transportation requestors to a single transportation provider may lead to inefficiencies if the transportation provider makes a detour to pick up a transportation requestor, passes through a traffic bottleneck, or is unable to take advantage of a high-occupancy vehicle (HOV) lane and/or toll discount. Additionally, some transportation providers may have constraints such as the distance the transportation provider is willing to travel and/or the area within with the transportation provider is willing to travel, reducing the pool of available transportation providers for a transportation requestor who desires to make a long trip. In some cases, a transportation requestor may already be en route to their destination but may have more efficient options by switching to a different transportation provider for the rest of the trip. By matching transportation requestors with one or more transportation providers via transfer points, a dynamic transportation matching system may increase the efficiency of trips for both transportation providers and transportation requestors. In some embodiments, the systems and methods described herein may provide advantages to a dynamic matching system by allocating resources more efficiently across different regions, areas, and/or types of transit areas. In some examples, the systems described herein may also provide advantages to a dynamic transportation matching system by efficiently distributing transportation requestors across different transit options throughout a region to minimize congestion, to minimize over-usage of some constrained transit options, and/or to minimize travel time of transportation providers and/or transportation requestors throughout the region.

Accordingly, as may be appreciated, the systems and methods described herein may improve the functioning of a computer that implements dynamic transportation matching. For example, these systems and methods may improve the functioning of the computer by improving dynamic transportation matching results. Furthermore, for the reasons mentioned above and to be discussed in greater detail below, the systems and methods described herein may provide advantages to dynamic transportation management and/or the field of transportation. In addition, these systems and methods may provide advantages to vehicles (whether piloted by a human driver or autonomous) that operate as a part of a dynamic transportation network. For example, the vehicles may complete transportation tasks more quickly, more efficiently (e.g., in terms of fuel, vehicle wear, etc.), and/or more safely (e.g., by driving, on average, shorter distances and/or times due to HOV lane usage, avoidance of traffic bottlenecks, and/or more efficient routes).

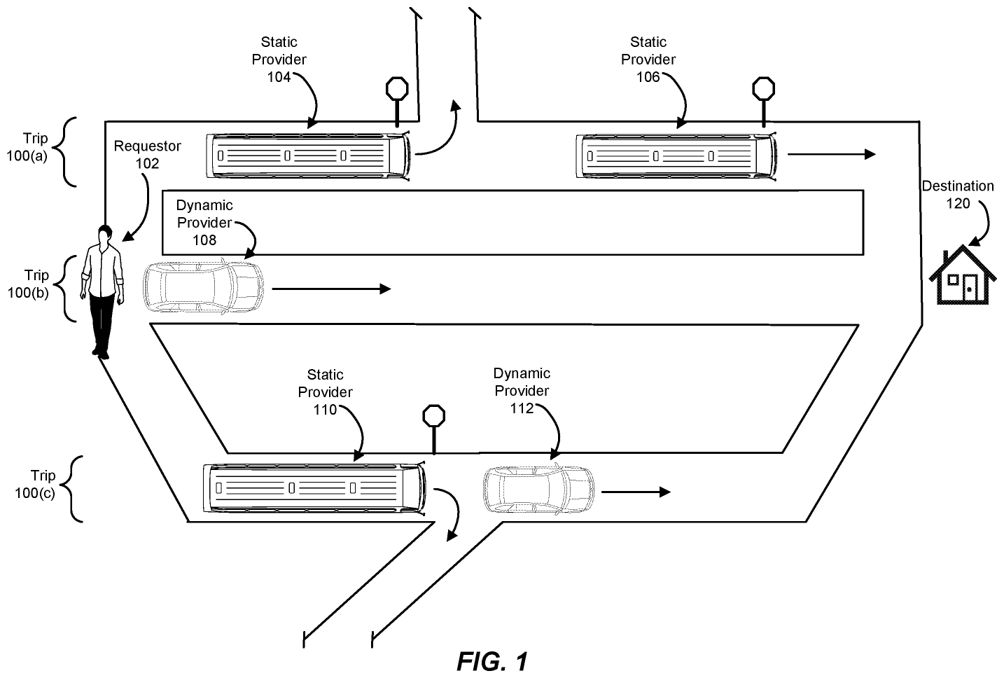

FIG. 1 illustrates a set of possible trips, trip 100(a), trip 100(b), and trip 100(c) that transport a transportation requestor 102 to a destination 120. In some examples, in trip 100(a), requestor 102 may meet a static provider 104. The term “static provider” or “static transportation provider,” as used herein, generally refers to a transportation provider with a predefined route and/or schedule that is not subject to change based on requests from transportation requestors. Examples of static transportation providers may include, without limitation, a bus that runs along a predefined route, an elevated train, a subway train, and/or a ferry. Because the route of static provider 104 may veer away from destination 120, requestor 102 may transfer to a second static provider, static provider 106, to complete the trip to destination 120. There are a number of drawbacks to trip 100(a), including increased travel time from extraneous stops performed by the static transportation providers, constraint to the schedules of the static transportation providers, and/or additional walking to and from pick-up and drop-off points for the static transportation providers.

In some examples, in trip 100(b), requestor 102 may meet a dynamic provider 108 that transports requestor 102 directly to destination 120. The term “dynamic provider” or “dynamic transportation provider,” as used herein, generally refers to any transportation provider that may be matched with a transportation requestor via a dynamic transportation matching system and may be directed to meet the transportation requestor at a specified location and/or transport the transportation requestor to a specified location. While the advantages of trip 100(b) over trip 100(a) are obvious, trip 100(b) does have drawbacks. In some cases, requestor 102 may be a lengthy distance from destination 120 and no dynamic transportation providers may be available who are willing to make the trip. In some examples, the cost of trip 100(b) may be significant due to the direct and on-demand nature of the service.

In some examples, in trip 100(c), requestor 102 may meet a static provider 110 and may then transfer to a dynamic provider 112 to complete the trip to destination 120. Because part of the trip is provided by a static provider, the total cost of trip 100(c) may be less than that of trip 100(b). However, because part of the trip is provided by a dynamic provider, the total duration of trip 100(c) may be significantly less than the duration of trip 100(a). In some embodiments, a dynamic transportation matching system may provide requestor 102 with the option to switch between static provider 110 and dynamic provider 112 at multiple points during the trip (e.g., multiple different bus stops), providing requestor 102 with a level of granularity to the duration-cost trade-off for the trip.

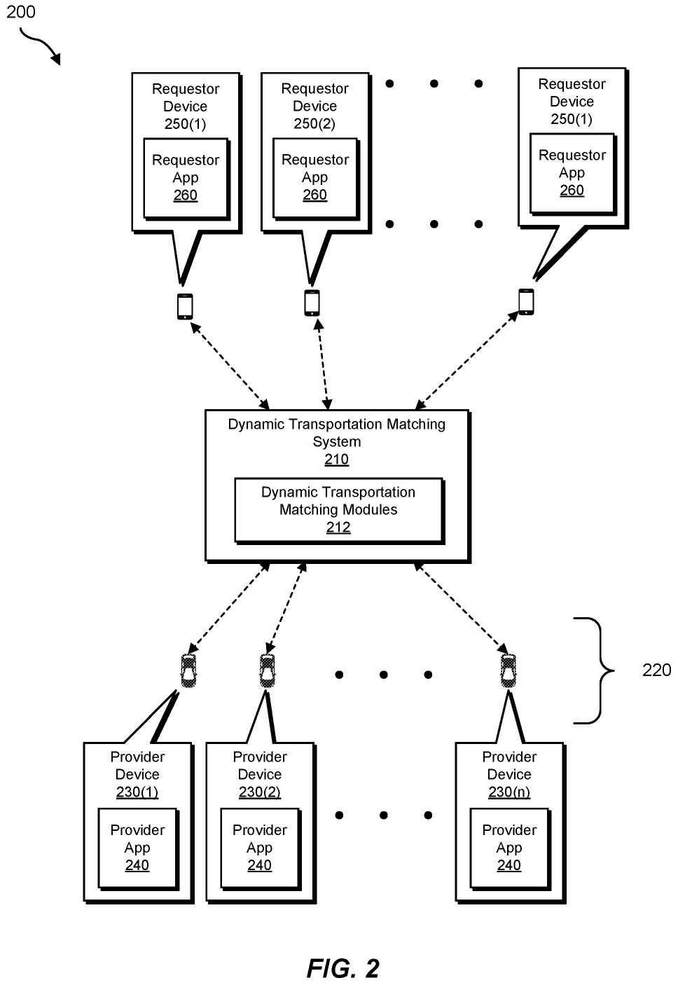

FIG. 2 illustrates an example system 200 for dynamic transfer-based transportation. As shown in FIG. 2, a dynamic transportation matching system 210 may be configured with one or more dynamic transportation matching modules 212 that may perform one or more of the steps described herein. Dynamic transportation matching system 210 may represent any computing system and/or set of computing systems capable of matching transportation requests and/or coordinating transportation transfers to and/or from transportation providers within a dynamic transportation network. Dynamic transportation matching system 210 may be in communication with computing devices in each of a group of vehicles 220 and/or with computing devices in each of a group of requestor devices 250(1)-(n). Vehicles 220 may represent any vehicles that may fulfill transportation requests. In some examples, vehicles 220 may include disparate vehicle models. In addition, in some examples, many or all of vehicles 220 may be standard commercially available vehicles. According to some examples, many or all of vehicles 220 may be owned by separate individuals (e.g., transportation providers). Furthermore, while, in some examples, many or all of vehicles 220 may be human-operated, in some examples many or all of vehicles 220 may be autonomous (or partly autonomous). Accordingly, throughout the instant disclosure, references to a “transportation provider” (or “provider”) may, where appropriate, refer to an autonomous vehicle, an owner of an autonomous vehicle, an operator of an autonomous vehicle, an attendant of an autonomous vehicle, and/or an autonomous system for piloting a vehicle. While FIG. 2 does not specify the number of vehicles 220, it may be readily appreciated that the systems described herein are applicable to hundreds of vehicles, thousands of vehicles, or more. In one example, dynamic transportation matching system 210 may coordinate transportation matchings within a single region for 50,000 vehicles or more on a given day. In some examples, vehicles 220 may collectively form a dynamic transportation network that may provide transportation supply on an on-demand basis to transportation requestors.

As mentioned above, dynamic transportation matching system 210 may communicate with computing devices in each of vehicles 220. The computing devices may be any suitable type of computing device. In some examples, one or more of the computing devices may be mobile devices. For example, one or more of the computing devices may be smartphones. Additionally or alternatively, one or more of the computing devices may be tablet computers, personal digital assistants, or any other type or form of mobile computing device. According to some examples, one or more of the computing devices may include wearable computing devices (e.g., a driver-wearable computing device), such as smart glasses, smart watches, etc. In some examples, one or more of the computing devices may be devices suitable for temporarily mounting in a vehicle (e.g., for use by a provider for a transportation matching application, a navigation application, and/or any other application suited for the use of providers). Additionally or alternatively, one or more of the computing devices may be devices suitable for installing in a vehicle and/or may be a vehicle's computer that has a transportation management system application installed on the computer in order to provide transportation services to transportation requestors and/or communicate with dynamic transportation matching system 210.

As shown in FIG. 2, vehicles 220 may include provider devices 230(1)-(n) (e.g., whether integrated into the vehicle, permanently affixed to the vehicle, temporarily affixed to the vehicle, worn by a driver of the vehicle, etc.). In some examples, provider devices 230 may include a provider app 240. Provider app 240 may represent any application, program, and/or module that may provide one or more services related to operating a vehicle and/or providing transportation matching services. For example, provider app 240 may include a transportation matching application for providers. In some examples, provider application 240 may match the user of provider app 240 (e.g., a transportation provider) with transportation requestors through communication with dynamic transportation matching system 210. In addition, and as is described in greater detail below, provider app 240 may provide dynamic transportation management system 210 with information about a provider (including, e.g., the current location of the provider) to enable dynamic transportation management system 210 to provide dynamic transportation matching and/or management services for the provider and one or more requestors. In some examples, provider app 240 may coordinate communications and/or a payment between a requestor and a provider. According to some embodiments, provider app 240 may provide a map service, a navigation service, a traffic notification service, and/or a geolocation service.

As mentioned above, dynamic transportation matching system 210 may communicate with each of requestor devices 250(1)-(n). The computing devices may be any suitable type of computing device, including but not limited to the computing devices discussed in connection with vehicles 220. In some examples, requestor devices 250(1)-(n) may include a requestor app 260. Requestor app 260 may represent any application, program, and/or module that may provide one or more services related to requesting transportation matching services and/or locating a transportation provider that has been matched to a requestor. For example, requestor app 260 may include a transportation matching application for requestors. In some examples, requestor app 260 may match the user of requestor app 260 (e.g., a transportation requestor) with transportation providers through communication with dynamic transportation matching system 210. In addition, and as is described in greater detail below, requestor app 260 may provide dynamic transportation management system 210 with information about a requestor (including, e.g., the current location of the requestor) to enable dynamic transportation management system 210 to provide dynamic transportation matching and/or management services for the requestor and one or more providers. In some examples, requestor app 260 may coordinate communications and/or a payment between a requestor and a provider. According to some embodiments, requestor app 260 may provide a map service, a navigation service, a traffic notification service, and/or a geolocation service. While FIG. 2 does not specify the number of requestor devices 250(1)-(n), it may be readily appreciated that the systems described herein are applicable to hundreds of requestors and their devices, thousands of requestors, or more.

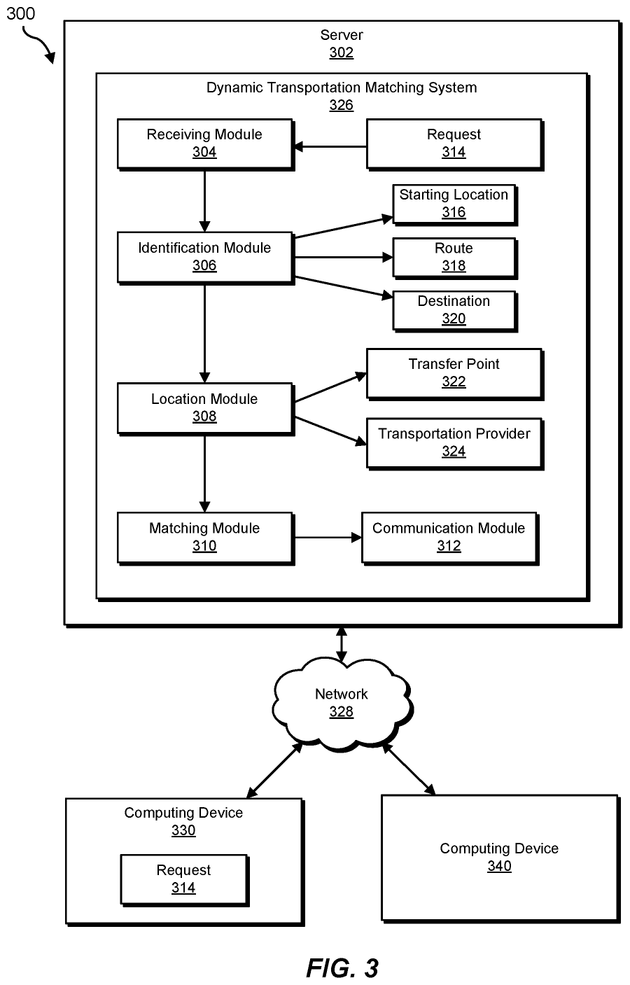

FIG. 3 illustrates an example system 300 for dynamic transfer-based transportation. In some embodiments, receiving module 304 may receive, by a dynamic transportation matching system 326, a request 314 from a transportation requestor for transport via a dynamic transportation network managed by dynamic transportation matching system 326. After receiving request 314, identification module 306 may identify, for the transportation requestor, a starting location 316, a route 318 of a first mode of transportation, and a destination 320. The first mode of transportation may be any of a variety of types of modes of transportation including but not limited to a bicycle, a scooter, a motorcycle, a car, a train, and/or a bus. Next, location module 308 may locate a transfer point 322 from the first mode of transportation of the transportation requestor to a transportation provider 324 that participates in and/or is associated with the dynamic transportation network, where transfer point 322 is based at least in part on route 318 of the first mode of transportation. In some examples, matching module 310 may match the transportation requestor with transportation provider 324 based at least in part on a fitness of transportation provider 324 to provide transportation from transfer point 322 to destination 320. Communication module 312 may fulfill request 314 from the transportation requestor by directing transportation provider 324 to meet the transportation requestor at transfer point 322 and transport the transportation requestor from transfer point 322 to destination 320. In some examples, dynamic transportation matching system 326 may direct transportation provider 324 by communicating with a computing device 340 operated by transportation provider 324. In some embodiments, dynamic transportation matching system 326 may be hosted on a server 302 and/or may communicate with a computing device 330 used by the transportation requestor to make request 314 via a network 328. Although illustrated as a single element, in some examples server 302 may represent one or more physical and/or virtual servers and/or computing devices communicating via a network (e.g., the cloud).

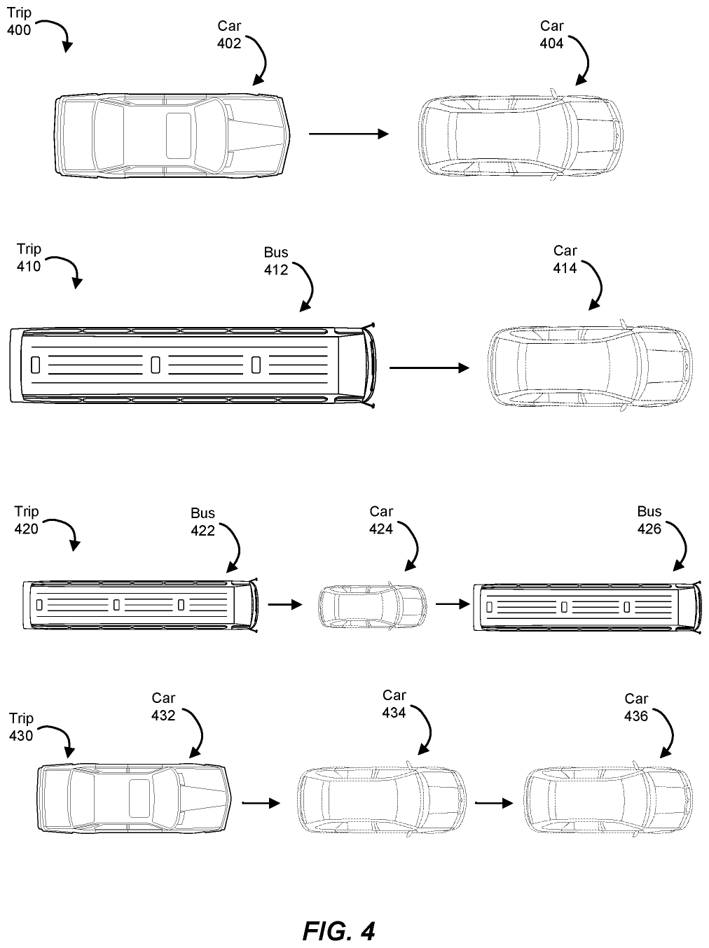

FIG. 4 illustrates an example set of trips involving dynamic transfers between multiple transportation providers. Although various transportation providers are illustrated in FIG. 4 as cars and buses, example transportation providers may include, without limitation, cars, scooters, bicycles, buses and/or trains. In some examples, in trip 400, a transportation requestor may begin a trip in car 402 and then transfer to car 404. In some examples, both car 402 and car 404 may be transportation providers who participate in a dynamic transportation network. In one example, a transportation requestor may request a medium-distance or long-distance trip and may, at the start of the trip, be matched with two transportation providers to complete the trip. For example, if a transportation requestor requests transportation from El Cerrito to Palo Alto, a dynamic transportation matching system may match the transportation requestor with car 402 for the leg of the trip from El Cerrito to San Francisco and with car 404 for the leg of the trip from San Francisco to Palo Alto. By splitting the trip into two legs with a transfer point in between, the dynamic transportation matching system may allow the drivers of car 402 and/or car 404 to remain within their preferred service areas and/or may reduce the cost to the transportation requestor due to the increase in the availability of drivers willing to contribute to a leg of the trip over the number of drivers willing to drive the entire trip. In some examples, the dynamic transportation matching system may match a transportation requestor with multiple transportation providers rather than a single transportation provider based on the distance of the trip, the constraints of the available transportation providers, the expected cost of the trip with various numbers of transportation provider, and/or the location and/or destinations of additional transportation requestors. For example, if car 402 is the nearest available transportation provider to a trip requestor but the operator of car 402 has requested to only make trips within a specified area, the dynamic transportation matching system may direct a transportation requestor to meet car 402 and then transfer to car 404 at a transfer point at the edge of the service area requested by the operator of car 402. In another example, the dynamic transportation matching system may determine that the distance from a transportation requestor's starting location to the requested destination exceeds a predetermined threshold for trip length and/or a threshold set by the operator of car 402 and may direct the transportation requestor to transfer from car 402 to car 404.

In some embodiments, the dynamic transportation matching system may arrange a transfer point between car 402 and car 404 at the start of the trip. In other embodiments, the dynamic transportation matching system may direct the transportation requestor to meet car 402 and may then search for transportation providers willing to meet car 402 and/or appropriate transfer points between car 402 and another transportation provider while the transportation requestor is en route via car 402.

In some examples, in trip 410, a transportation requestor may begin a trip on a static transportation provider such as bus 412 that does not participate in the dynamic transportation network and may then transfer to a dynamic transportation provider such as car 414. In one example, the dynamic transportation matching system may, at the start of the trip, direct the transportation requestor to meet bus 412 and then meet car 414 at a transfer point. In another example, the transportation requestor may be en route to a destination via bus 412 and the dynamic transportation matching system may alert the transportation requestor that car 414 is available to take the transportation requestor to their destination with a reduced duration and/or increased comfort level than bus 412.

In one example, in trip 420, a transportation requestor may complete a trip via a bus 422 that does not participate in the dynamic transportation matching network, a car 424 that participates in and/or is associated with the dynamic transportation matching network, and a bus 426 that does not participate in the dynamic transportation matching network. For example, the transportation requestor may intend a trip with a starting point and destination that are easily accessible by two different public transportation networks that do not interface. In this example, the dynamic transportation matching network may suggest a transfer point between bus 422 and car 424 and another transfer point between car 424 and bus 426. In some examples, a trip that is partially via public transit and partially via a dynamic transportation provider may be less expensive than a direct trip entirely via a dynamic transportation provider and the dynamic transportation matching system may calculate the cost of each potential trip and then suggest trip 420 to the transportation requestor due to the transportation requestor's preference for less expensive trips.

In some examples, a trip 430 may include a car 432, a car 434, and a car 436, all of which may participate in a dynamic transportation network. In one example, trip 430 may be a long-distance trip. For example, if a transportation requestor requests transportation from Oakland to Santa Cruz, there may be few or no transportation providers willing to provide transportation along the entire route and/or the cost may be prohibitive. In one example, car 432 may provide transportation from Oakland to Fremont, car 434 may provide transportation from Fremont to San Jose, and car 436 may provide transportation from San Jose to Santa Cruz. In some examples, composing a trip of multiple shorter legs may enable the dynamic transportation matching system to match the transportation requestor with other transportation requestors, reducing the cost for the transportation requestor and increasing efficiency for the transportation providers. For example, while there may be only one transportation requestor who requests transportation from Oakland to Santa Cruz, there may be multiple transportation requestors who request transportation from Oakland to Fremont, Fremont to San Jose, or San Jose to Santa Cruz. In some examples, the dynamic transportation matching system may calculate the time and/or cost of the trip for the transportation requestor if the trip is made via one transportation provider and may also calculate the time and/or cost of the trip if the trip is made via transferring to additional transportation providers (e.g., that are also transporting other transportation requestors) at various different transfer points. In some examples, the dynamic transportation matching system may determine transfer points based at least in part on the location of other transportation requestors. For example, if another transportation requestor requests transportation from downtown San Jose to Santa Cruz, the dynamic transportation matching system may select a transfer point between car 434 and car 436 in downtown San Jose. In another example, if the additional transportation requestor instead requests transportation from South San Jose to Santa Cruz, the dynamic transportation matching system may instead locate the transfer point between car 434 and car 436 in South San Jose based at least in part on the location of the additional transportation requestor.

In some examples, the dynamic transportation matching system may match transportation providers with transportation requestors in order to benefit potential future transfers. For example, the dynamic transportation matching system may match providers with requestors and/or route providers in order to concentrate high-capacity vehicles along high-density corridors. In one example, the dynamic transportation matching system may match a transportation provider with a vehicle that has five available seats with a transportation requestor whose destination is a popular downtown area in order to increase the likelihood that the transportation provider will be available to meet additional transportation requestors at transfer points. Similarly, the dynamic transportation matching system may match a transportation requestor going to an out-of-the-way destination with a transportation provider that only has one available seat (e.g., a motorcycle) rather than a transportation provider with more available seats because there may be a smaller likelihood of additional transportation requestors requesting transfers near the out-of-the-way destination. Additionally or alternatively, the dynamic transportation matching system may select a route for a transportation provider that increases potential transfer opportunities. In one example, the dynamic transportation matching system may direct a transportation provider to take a route that predominantly features surface streets over a route that predominantly features highway driving in order to increase the availability of the transportation provider to meet transportation requestors at transfer points. In another example, the dynamic transportation matching system may route a transportation provider through a first neighborhood instead of a second neighborhood because the first neighborhood has a higher density of static transfer points and/or a higher historical rate of being the location of dynamically generated transfer points.

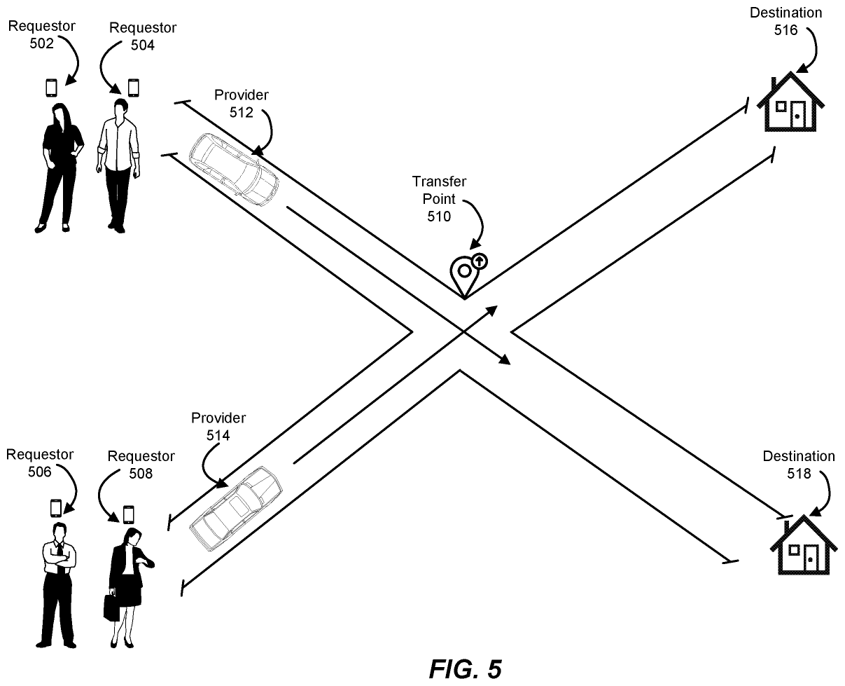

FIG. 5 illustrates an example set of transportation requestors and transportation providers. In one example, a requestor 502 may have a destination 516, while a requestor 504 at the same or a nearby starting point may have a destination 518. In this example, a requestor 506 may also have a destination at or near destination 516 while a requestor 508 who is near requestor 506 may have a destination at or near destination 518. Without transfer points, each requestor would have to take a different vehicle to their destination or two of the requestors would be highly inconvenienced by detours. However, with dynamic transfers, provider 512 may transport requestor 502 and requestor 504 to transfer point 510. Provider 514 may also transport requestor 506 and requestor 508 to transfer point 510. At transfer point 510, requestor 502 may switch to provider 514 while requestor 508 may switch to provider 512. Provider 512 may then continue to destination 518, transporting requestor 504 and requestor 508, while provider 514 may continue to destination 516, transporting requestor 502 and requestor 506. By transferring at transfer point 510 and carpooling rather than taking individual vehicles, the transportation requestors may reduce the cost of their trips. Additionally, because each vehicle is transporting two transportation requestors rather than one, the transportation providers may be able to take advantage of HOV lanes and/or reduced tolls that are available to vehicles with three or more occupants. In some embodiments, the dynamic transportation matching system may compare starting points and/or destinations for all trip requestors within a specified area in order to arrange trips that include efficient transfers. Additionally or alternatively, the dynamic transportation matching system may compare the cost, duration, and/or convenience of each individual trip requestor's trip with and without various possible transfers.

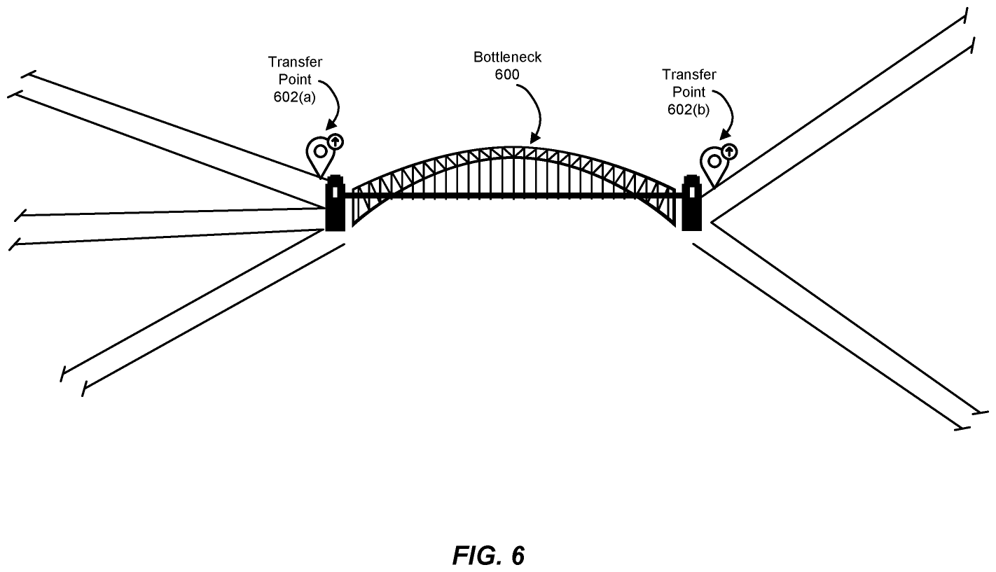

FIG. 6 illustrates an example bottleneck with transfer points on either side. Although illustrated as a bridge, bottleneck 600 may represent any of a variety of traffic bottlenecks, including but not limited to bridges, tunnels, inspection checkpoints, and/or toll booths. In some examples, it may be more efficient for a transportation requestor and/or transportation provider for the transportation requestor to take one provider to transfer point 602(a) on one side of bottleneck 600 and then meet a different provider at transfer point 602(b) on the other side of the bottleneck. For example, it may take less time for a pedestrian to navigate a busy bridge than for a car to drive across the bridge. In some examples, a pedestrian may be able to cross a bridge without paying a toll while a car may not, and crossing the bridge on foot may provide worthwhile savings for the transportation requestor.

A dynamic transportation matching system may identify a bottleneck in a variety of ways. For example, the dynamic transportation matching system may use historical traffic data to identify traffic bottlenecks. Additionally or alternatively, the dynamic transportation network may use user-reported data (e.g., data gathered from transportation requestors and/or transportation providers) to identify traffic bottlenecks. In some examples, the dynamic transportation matching system may identify a bottleneck by identifying that the average speed on a particular stretch of road is below a predetermined threshold. Additionally or alternatively, the dynamic transportation system may identify bottlenecks at least in part by how much traffic passes through a specified area. For example, if the average speed of traffic on a bridge is below ten miles per hour and more than one thousand vehicles pass through the bridge per day, the dynamic transportation matching system may determine that the bridge is a bottleneck.

The dynamic transportation matching system may determine whether to suggest a transfer at a bottleneck for a particular trip in a variety of ways. In some examples, the dynamic transportation matching system may calculate the estimated trip time for the transportation requestor with and without a transfer and may suggest that the transportation requestor transfer at the bottleneck rather than being transported through the bottleneck if the time savings caused by the transfer is above a predetermined threshold and/or a threshold set in the preferences of the transportation requestor. In other examples, the dynamic transportation matching system may determine the estimated amount of transportation provider time saved by the transfer and may provide incentives for a transportation requestor to transfer at the bottleneck in order to increase transportation provider availability to transport other transportation requestors and/or increase transportation provider retention by reducing transportation provider frustration.

In some cases, a transportation requestor may be dropped off at one transfer point and picked up at another nearby transfer point even if no bottleneck exists. For example, a transportation requestor may be dropped off along with an additional transportation requestor at the additional transportation requestor's destination and may then walk a few blocks to where a third transportation requestor is meeting the next transportation provider.

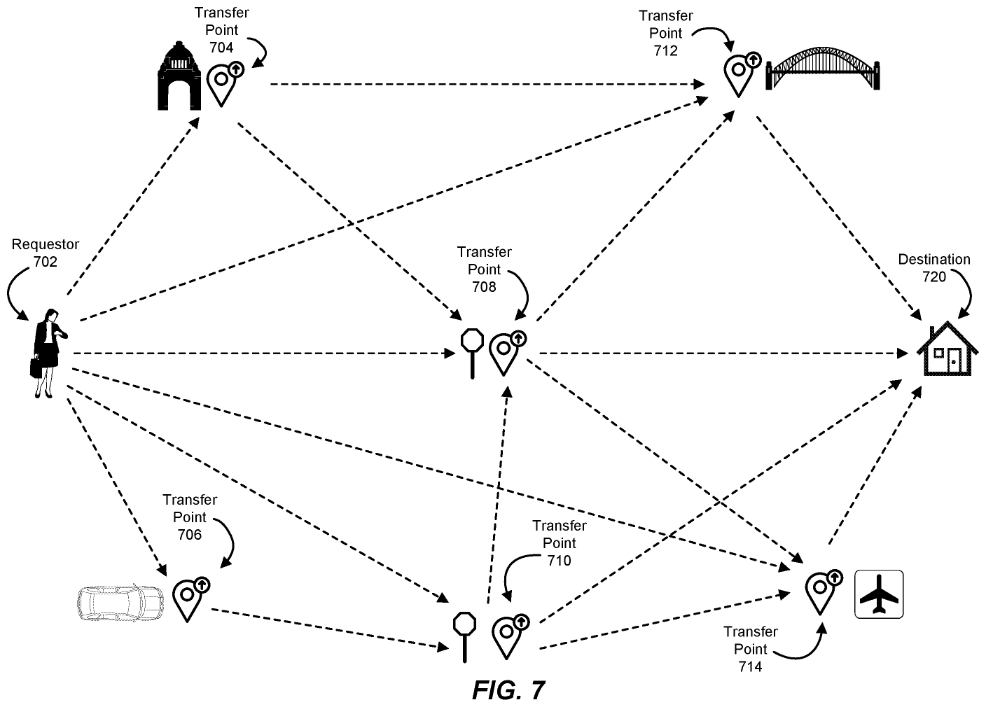

FIG. 7 illustrates a set of example static transfer points. In some embodiments, a dynamic transportation matching system may dynamically determine transfer points based on the location and/or preferences of one or more transportation requestors and/or transportation providers that the dynamic transportation matching system will direct to the transfer point. Additionally or alternatively, a dynamic transportation matching system may maintain a list of static transfer points and may direct transportation providers and/or transportation requestors to a transfer point from the list of transfer points based on location and/or preferences. For example, as illustrated in FIG. 7, a requestor 702 may have a destination 720 with numerous transfer points located in between the requestor 702 and the destination 720. In some examples, some transfer points, such as transfer point 708 and/or transfer point 710, may be located at public transportation stops, stations, hubs, and/or terminals. For example, transfer point 710 may be located at a bus stop and/or transfer point 708 may be located at a hub for several public transit services. Locating static transfer points for the dynamic transportation network at or near exiting transfer points for public transit may enable transportation requestors to conveniently transfer between different modes of transportation. In some example, the dynamic transportation matching system may suggest that a transportation requestor meet a dynamic transportation provider at a static transfer point located at a public transportation stop if the transportation requestor is currently traveling via public transit. For example, the dynamic transportation matching system may match a transportation requestor who is currently riding the bus with a transportation provider and direct the transportation requestor and transportation provider to meet at the next bus stop on the bus's route.

In some examples, transfer points may be located in areas that are a common starting point and/or destination for many transportation requestors. For example, transfer point 714 may be located at an airport. Locating static transfer points at common starting points and/or destinations may enable the dynamic transportation matching system to increase efficiency for multiple transportation requestors sharing a transportation provider. For example, there may be an additional transportation requestor near requestor 702 who requests transportation to the airport and a third transportation requestor at the airport who requests transportation to somewhere in the same direction as destination 720. By transferring at transfer point 714 at the airport, requestor 702 may benefit from the cost savings of sharing a transportation provider for the trip even if no other transportation requestor requested transportation directly from the starting point of requestor 702 to destination 720. Therefore, based on the decreased cost for requestor 702, the dynamic transportation matching system may match requestor 702 with one transportation provider that transports requestor 702 to transfer point 714 and an additional transportation provider that transports requestor 702 from transfer point 714 to destination 720.

In some examples, static transfer points may be located at traffic bottlenecks and/or points that are commonly passed through on many trips taken via the dynamic transportation network. For example, transfer point 712 may be located at a bridge. In some examples, even though few transportation requestors may start or end their trips at a particular location, a transfer point may be an efficient transfer point due to being located along the route of many trips. For example, the San Francisco Bay Bridge may not be a common starting point or destination for regular commuters, but many commuters between Oakland or Berkeley and San Francisco pass through the San Francisco Bay Bridge on a regular basis. In this example, locating a transfer point at the San Francisco Bay Bridge may enable ride requestors who start in similar locations in San Francisco but have different ultimate destinations in Oakland to share a transportation provider to the San Francisco Bay Bridge before transferring to two different transportation providers. Similarly, the transportation providers for the Oakland leg of each transportation requestor's journey may have arrived at the San Francisco Bay Bridge carrying transportation requestors who started at different points in Berkeley and Oakland but are heading towards the same general destination in San Francisco. By locating transfer points at places that are along commonly used routes, the dynamic transportation matching system may increase the efficiency with which transportation requestors are matched with other transportation requestors who share a similar starting point or destination but not both. In some examples, the dynamic transportation matching system may direct a transportation requestor to transfer at a commonly passed-through transfer point in response to locating at least one additional transportation requestor with a similar starting point and/or destination to the transportation requestor. Additionally or alternatively, the dynamic transportation matching system may locate transfer points at places along the boundaries of defined areas. For example, if a particular transportation provider requests to operate only in Oakland or only in San Francisco, the San Francisco Bay Bridge may be a convenient transfer point to pick up and/or drop off transportation requestors with starting points and/or destinations outside the designated area.

In some examples, static transfer points may be located at points of interest that are easily findable landmarks for transportation requestors. For example, transfer point 704 may be located at a monument. In some examples, the dynamic transfer matching system may direct a transportation requestor to meet a transportation provider at a landmark if the transportation requestor is a predetermined distance away from a typical local area of the transportation requestor. In other examples, the dynamic transfer matching system may direct the transportation requestor to meet a transportation provider at a landmark because the landmark is the most time and/or cost-efficient transfer point for the transportation requestor. Additionally or alternatively, static transfer points may be located at locations with no previous significance that are convenient to the dynamic transportation matching system. For example, transfer point 706 may be located at a street corner that has no particular landmarks or public infrastructure but is in an efficient location for transfer to and/or from a variety of destinations. In some embodiments, static transfer points may be marked with signs to indicate the location and/or usage of the transfer point. For example, transfer point 706 may have a sign that reads “LYFT transfer point.” In some examples, the dynamic transportation matching system may designate a static transfer point after analyzing transportation requestor and/or transportation provider trips in the area and determining that a particular location is centrally located and/or otherwise efficiently accessible as a transfer point for at least a predetermined number and/or percentage of trips. In one example, a dynamic transportation matching system may direct a transportation requestor and transportation provider to meet at a static transfer point that is not otherwise significant based at least in part on the static transportation point being close to the current location and/or expected route of the transportation requestor and/or transportation provider.

In some examples, the dynamic transportation matching system may select a transfer point for a particular trip based on characteristics of the transfer point other than nearness to the transportation requestors and/or transportation providers. For example, the dynamic transportation matching system may store information about transfer point characteristics such as safety, shelter from inclement weather, and/or other amenities and may select a transfer point based on one or more of these characteristics. In one example, the dynamic transportation matching system may only select transfer points with a safety rating about a certain threshold for trips that take place during certain hours (e.g., at night) and/or transportation requestors who have indicated a preference for safer transfer points. In another example, the dynamic transportation matching system may avoid selecting an otherwise-convenient transfer point with no shelter from inclement weather during a trip when it is raining heavily and may instead select a slightly less efficient transfer point that features a bus shelter. In some embodiments, information about characteristics of transfer points may be derived from historical data, map attributes, and/or crowdsourced information.

In some embodiments, the dynamic transportation matching system may enable transportation requestors to configure a set of preferences for transfer point selection. For example, some transportation requestors may prefer to use the transfer point that will result in the least expensive trip, even if the transfer point is does not offer as many amenities as a different transfer point. Additionally or alternatively, the dynamic transportation matching system may enable transportation providers to configure preferences for transfer points. For example, some transportation providers may prefer to meet transportation requestors at transfer points with certain amenities, such as good lighting.

Additionally or alternatively, the dynamic transportation matching system may use dynamic transfer points. In some embodiments, the dynamic transportation matching system may locate a dynamic transfer point when a transportation requestor requests transportation and/or during a transportation requestor's trip rather than selecting a static transfer point from a predetermined list of transfer points. In some examples, the dynamic transportation matching system may locate a dynamic transfer point by selecting a location that is close to the current location and/or expected route of a transportation provider that is currently transporting a transportation requestor and an additional transportation provider that has been matched with the transportation requestor. In another example, the dynamic transportation matching system may direct a transportation provider to drop off a transportation requestor at a dynamic transfer point in a location near a variety of transportation providers and may later (e.g., after directing the transportation provider to travel to the transfer point but before the transportation provider reaches the transfer point) direct one of the nearby transportation providers to meet the transportation requestor at the transfer point. In some examples, the dynamic transportation matching system may determine dynamic transfer points based on the locations and/or expected routes of more than one transportation requestor and/or transportation provider. For example, two transportation requestors may have different starting points but the same destination and the dynamic transportation matching system may determine a dynamic transfer point at which the first transportation requestor may meet and transfer into the transportation provider transporting the second transportation requestor based at least in part on the location and/or expected route of both the first and the second transportation requestors.

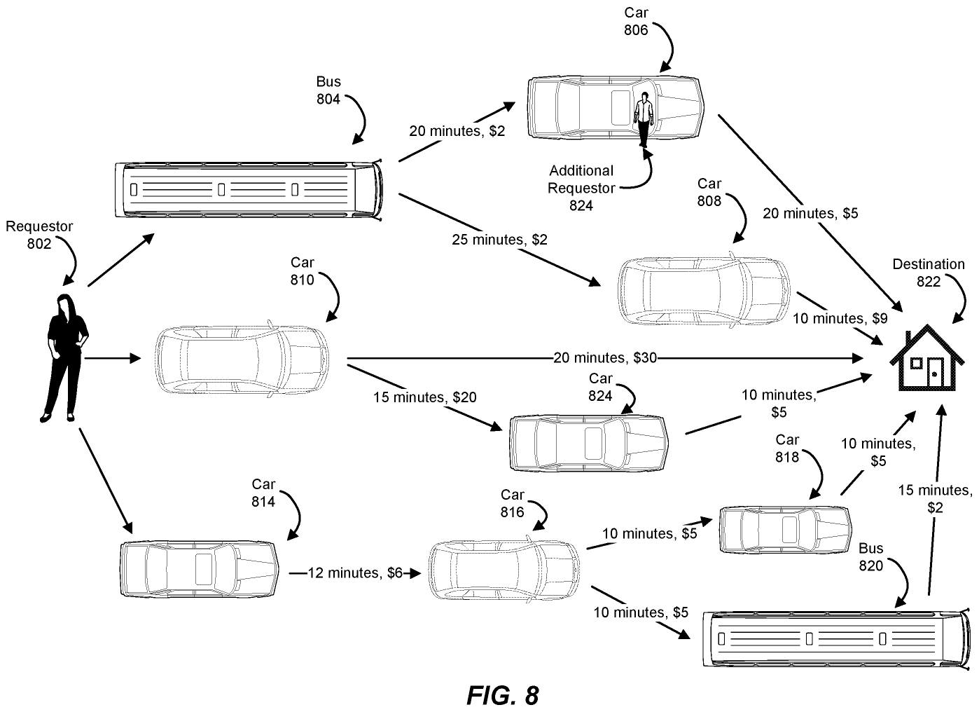

FIG. 8 illustrates an example set of trips for a requestor 802 to a destination 822. Each trip has various trade-offs in terms of time, cost, and/or convenience. For example, the most direct trip, via car 810, is also the most expensive trip. The cheapest trip, via bus 804 and car 806 that is also transporting additional requestor 824, has the longest duration. Various intermediate options, such as transferring from bus 804 to car 808 rather than car 806, transferring to car 824 from car 810, or taking car 814 to car 816 and then transferring to either car 818 or bus 820, may offer different levels of trade-off between trip duration, convenience, and/or cost.

In some examples, requestor 802 may request transportation to destination 822 and the dynamic transportation matching system may display various available trip options to requestor 802. In other examples, requestor 802 may have preselected settings about trip preferences and/or have historical data about trip preferences and the dynamic transportation matching system may only display trips that match the preferences of requestor 802. For example, if requestor 802 configured a preference for the least expensive trip and/or has historically selected the least expensive trip out of the available options, the dynamic transportation matching system may calculate the costs of various potential trips and then suggest meeting bus 804 and then transferring to car 806. In another example, if requestor 802 selected preferences for the least expensive trip that did not involve public transit or carpooling, the dynamic transportation matching system may calculate the costs of various potential trips while excluding trips that involve carpooling or public transit and then suggest meeting car 814, transferring to car 816, and then transferring to car 818.

In some examples, the dynamic transportation matching system may locate transportation providers and/or transfer spots in response to a manual request submitted by a transportation requestor. Additionally or alternatively, the dynamic transportation matching system may locate transportation providers and/or transfer spots in response to detecting that the transportation requestor has requested to be notified when transportation meeting certain conditions is available and those conditions have been satisfied. For example, requestor 802 may be en route to destination 822 via bus 804 and may have requested to be notified whenever faster transportation is available. In this example, the dynamic transportation matching system may notify requestor 802 that car 808 is available to transport requestor 802 to destination 822 and/or may notify requestor 802 to exit bus 804 at the next bus stop to transfer to car 808.

In some embodiments, the dynamic transportation matching system may recommend a transfer to a transportation requestor at least in part to offer utility to one or more transportation providers. In some examples, the dynamic transportation matching system may generate a trip itinerary that keeps a transportation provider within a specified area requested by the transportation provider, ends with the transportation provider near an endpoint specified by the transportation provider, and/or involves a transportation provider that would otherwise be idle. For example, if there are few transportation requestors in a certain area at a certain time, the dynamic transportation matching system may offer discounts to transportation requestors that transfer between two transportation providers in order to generate trips for more transportation providers (e.g., in order to prevent transportation provider attrition due to idleness). In some examples, the dynamic transportation matching system may calculate the ratio of transportation requestors to transportation providers in a particular area while determining whether to direct a transportation requestor to transfer between transportation providers. In one example, the dynamic transportation matching system may arrange transfer points to increase the amount of carpooling and reduce the number of transportation providers needed during peak transportation hours (e.g., rush hour). In some embodiments, the dynamic transportation matching system may include constraints related to transportation requestor preferences when determining available trip itineraries for a transportation requestor.

In some examples, the dynamic transportation matching system may suggest a transfer to a transportation requestor based at least in part on characteristics of the transportation provider currently transporting the transportation requestor. For example, if a single transportation requestor is being transported by a large vehicle with room for six people and a party of six transportation requestors requests a transportation provider, the dynamic transportation matching system may locate a transfer point and/or transportation provider near the single transportation requestor and/or may offer the single transportation requestor a discount to transfer from the large vehicle into a smaller vehicle so that the large vehicle is available to transport the party of six transportation requestors. In some embodiments, when matching a transportation provider with a transportation requestor, the dynamic transfer matching system may consider not just available transportation providers but also transportation providers currently transporting transportation requestors who could be directed to transfer to a different transportation provider. For example, the dynamic transportation matching system, upon receiving a request to transport a party of six, may match the party of six with the transportation provider that has room for six transportation requestors even though that transportation provider is currently transporting the single transportation requestor.

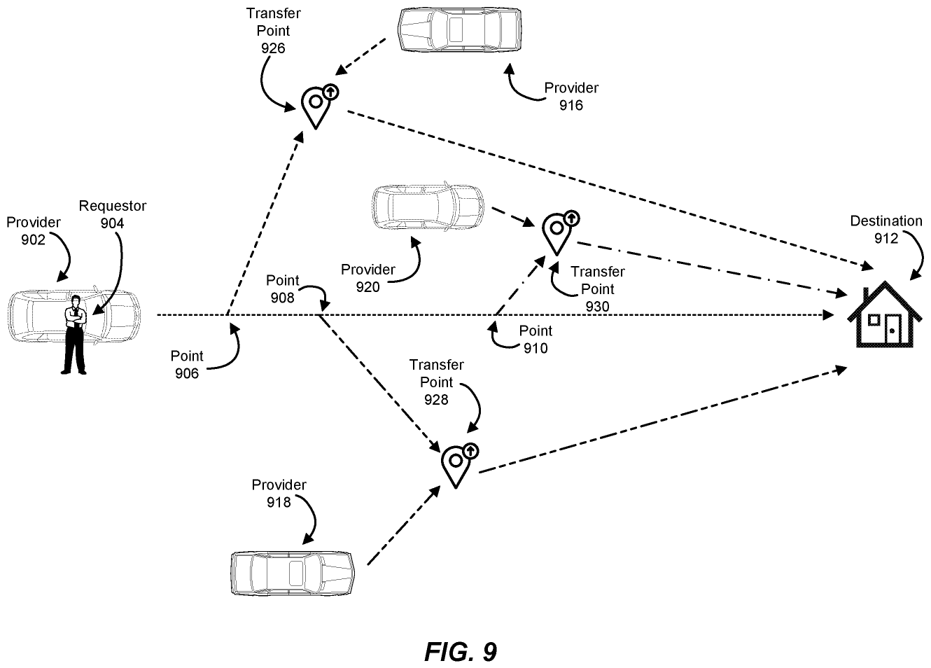

FIG. 9 illustrates a variety of potential transfer points for requestor 904 on the way to destination 912. In some embodiments, the dynamic transportation matching system may continuously and/or periodically search for transfer points for a transportation requestor who is en route. For example, requestor 904 may be en route to destination 912 via a provider 902. As provider 902 approaches point 906 along the route to destination 912, the dynamic transportation matching system may suggest meeting provider 916 at transfer point 926. Once provider 902 has passed point 906, transferring to provider 916 may no longer be efficient. As provider 902 approaches point 908 along the route, the dynamic transportation system may suggest meeting provider 918 at transfer point 928. Once provider 902 has passed point 908 and approaches point 910, it may be more efficient to instead transfer to provider 920 at transfer point 930. In some examples, requestor 904 may not have initially requested a trip that includes a transfer. However, in some examples, the dynamic transportation matching system may still present requestor 904 with one or more opportunities to transfer if a better (e.g., faster, less expensive, more comfortable) trip is available via a transfer. Additionally or alternatively, an operator of a transportation provider may initiate a search for a transfer location. For example, provider 902 may cancel the trip mid-trip, triggering the dynamic transportation matching system to locate a transfer point for requestor 904.

In some embodiments, the dynamic transfer matching system may plan out routes with transfer points and additional providers at the start of a trip. Additionally or alternatively, the dynamic transfer matching system may match a transportation requestor with a transportation provider traveling in the general direction of the transportation requestor's destination and may search for transfer points while en route. In some embodiments, when searching for potential transfer, the dynamic transportation matching system may take into account the state of the other transportation providers and/or their passengers and their willingness to perform certain actions (e.g., tolerance to waiting, walking). For example, if a particular transportation provider has indicated an unwillingness to wait more than three minutes to meet a transportation requestor, the dynamic transfer matching system may select a transfer point that requires the transportation provider to do more driving but less waiting. In another example, if a particular transportation requestor has indicated a high tolerance for walking (e.g., by configuring a preference with a maximum walking distance of half a mile) and a preference for lower-cost trips, the dynamic transportation matching system may select a transfer point that requires a significant amount of walking on the part of the transportation requestor but reduces the cost of the trip. In one example, if a first transportation provider is transporting a transportation requestor that has indicated a low tolerance for waiting, the dynamic transportation matching system may instead match a second transportation provider with a transportation requestor who is not expected to reach the transfer point for another few minutes, even if the second transportation provider is farther away from the transfer point than the first transportation provider. In some embodiments, the dynamic transportation matching system may use a network flow algorithm to determine transfer points. Additionally or alternative, the dynamic transportation matching system may use a real-time marginal cost attribution algorithm to determine transfer points.

In some embodiments, the dynamic transportation matching system may direct a transportation provider to a transfer point by giving directions to the transfer point. For example, the dynamic transportation matching system may send the street address and/or coordinates of the transfer point to a navigation application used by the transportation provider. In one embodiment, the dynamic transportation matching system may give the transportation provider information about the state of the transportation provider that is transporting the transportation requestor to the transfer point and/or whether the transportation requestor is not on a transportation provider and is currently walking to and/or waiting at the transfer point. In some embodiments, the dynamic transportation matching system may display information to a transportation requestor about the state of the incoming transportation provider and/or enable the transportation requestor to submit feedback about the quality of the transfer.

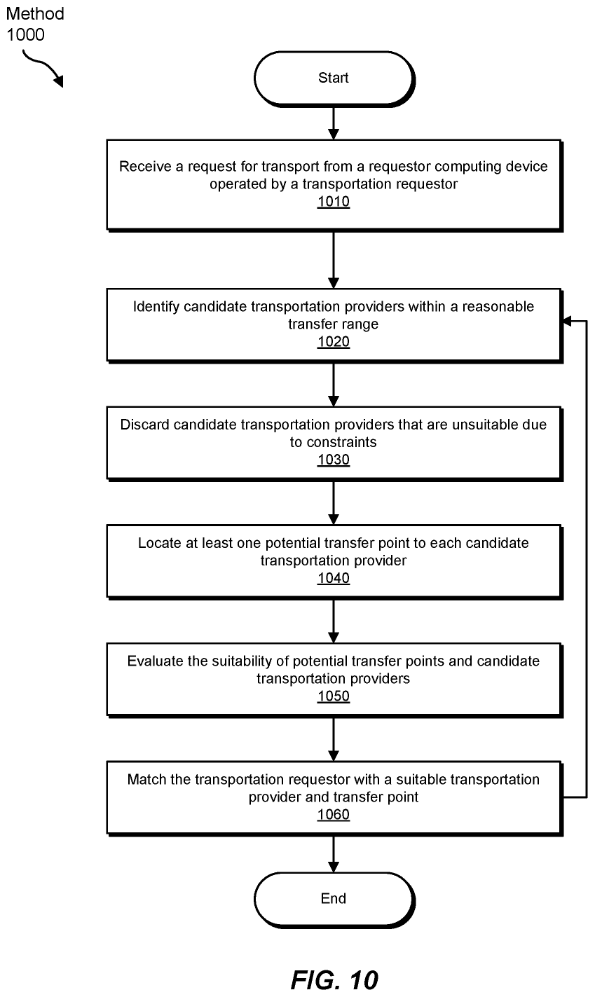

FIG. 10 illustrated an example method 1000 for dynamic transfer-based transportation. Example method 1000 illustrates one of many possible decision flows for arrange a transfer for a transportation requestor. In some examples, at step 1010, the systems described herein may receive a request for transport from a requestor computing device operated by a transportation requestor. In one example, the transportation requestor may be en route to a destination when the systems described herein receive the request. At step 1020, the systems described herein may identify candidate transportation providers within a reasonable transfer range. In some examples, the systems described herein may define a reasonable transfer range based on travel distance, travel time, and/or travel cost. For example, the systems described herein may identify candidate transportation providers within 10 miles and/or within a 10-minute driving range and/or may exclude candidate transportation providers that would have to pay more than $2 in tolls to reach a transfer point. In some examples, the systems described herein may factor the expected future location of candidate transportation providers. For example, a provider that is 15 miles away but heading towards the transportation requestor may be considered as a candidate transportation provider while a provider that is 10 miles away but heading away from the transportation requestor may not be considered.

At step 1030, the systems described herein may discard candidate transportation providers that are unsuitable due to constraints. In some examples, the systems described herein may discard candidate transportation providers based on constraints of the candidate transportation provider. For example, if a transportation requestor requests transport for four people and a candidate transportation provider has only two available seats, the systems described herein may discard the candidate transportation provider. In another example, if a transportation requestor requests transport to a destination outside of a candidate transportation provider's preferred travel area, the systems described herein may discard the candidate transportation provider. In one example, if a candidate transportation provider is already transporting another transportation requestor whose destination is not compatible with the destination of the transportation requestor, the systems described herein may discard the candidate transportation requestor. In some examples, the systems described herein may discard candidate transportation providers based on the transportation requestor's preferences. For example, if the transportation requestor prefers to avoid sharing a transportation provider with other transportation requestors, the systems described herein may discard any candidate transportation providers that are already transporting another transportation requestor who is not expected to imminently depart the transportation provider. Additionally or alternatively, the systems described herein may discard candidate transportation providers due to constraints on the dynamic transportation network. For example, if the transportation requestor requests transport for a single person and a candidate transportation provider has six available seats, the systems described herein may discard the candidate transportation provider in order to keep those seats available for larger parties of transportation requestors.

In some embodiments, steps 1020 and 1030 may be reversed and/or broken down into multiple sub-steps. For example, the systems described herein may identify transportation providers that match certain constraints and then discard transportation providers that are too far away from the transportation requestor.

At step 1040, the systems described herein may locate at least one potential transfer point to each candidate transportation provider. The systems described herein may locate potential transfer points in a variety of ways. For example, the systems described herein may select from a list of static transfer points. Additionally or alternatively, the systems described herein may dynamically select locations to function as transfer points. In some examples, the systems described herein may locate transfer points based on transportation requestor preferences. For example, the systems described herein may locate transfer points with a desired amenity, such as a weather shelter. In another example, the systems described herein may generate dynamic transfer points based at least in part on a maximum walking distance between transfer points specified by the transportation requestor. In other examples, the systems described herein may locate transfer points based on transportation provider preferences. For example, if a transportation provider has indicated an unwillingness to wait more than five minutes to meet a transportation requestor, the systems described herein may locate transfer points for that transportation provider that are reachable by the transportation requestor within five minutes of the expected arrival time of the transportation provider at the transfer point. Additionally or alternatively, the systems described herein may locate transfer points based at least in part on the proximity of the transfer point to potential future transfer points to meet additional transportation requestors.

At step 1050, the systems described herein may evaluate the suitability of potential transfer points and candidate transportation providers based on a variety of criteria. For example, the systems described herein may evaluate the total travel time for the transportation requestor of trips involving various potential transfer points and/or candidate transportation providers. The systems described herein may evaluate various environmental factors and/or candidate transportation provider characteristics that contribute to travel time. For example, the systems described herein may determine that a candidate transportation provider that is an electric vehicle may provide a shorter travel time than a candidate transportation provider that is not an electric vehicle due to the electric vehicle's ability to use express lanes which may currently be experiencing less traffic than other lanes. Similarly, the systems described herein may determine that a candidate transportation provider that is currently and/or expected to be transporting an additional transportation requestor may provide a shorter travel time due to the candidate transportation provider's ability to use high-occupancy vehicle lanes that require a minimum of three passengers. In another example, the systems described herein may evaluate the total monetary cost for the transportation requestor of trips involving various potential transfer points and/or candidate transportation providers. In some embodiments, the systems described herein may present the transportation requestor with a list of potential candidate transportation providers and/or transfer points and enable the transportation requestor to select among the list. Additionally or alternatively, the systems described herein may present one or more candidate transportation providers with the option to transport the transportation requestor and/or information about one or more potential transfer points for meeting the transportation requestor.

At step 1060, the systems described herein may match the transportation requestor with a suitable transportation provider and transfer point selected from the candidate transportation providers and potential transfer points. In some examples, the systems described herein may then direct the transportation provider and transportation requestor to meet at the transfer point. In some examples, the systems described herein may not find a suitable transportation provider and/or transfer point and may not match the transportation requestor with a transportation provider and/or transfer point. For example, if the transportation requestor is currently en route to a destination, the systems described herein may determine that no available transportation provider is more suitable than the current mode of transportation of the transportation requestor and may therefore not direct the transportation requestor to meet a transportation provider at a transfer point.

In some examples, the systems described herein may return to step 1020 after presenting the transportation requestor with at least one suitable transportation provider and/or transfer point. For example, the transportation requestor may choose not to transfer and may continue along their previous route to their destination. In this example, the systems described herein may continue dynamically locating candidate transportation providers and/or potential transportation points during the transportation requestor's trip, each time updating the calculations to reflect the new locations and/or states of the transportation requestor, candidate transportation providers, and/or transfer points.

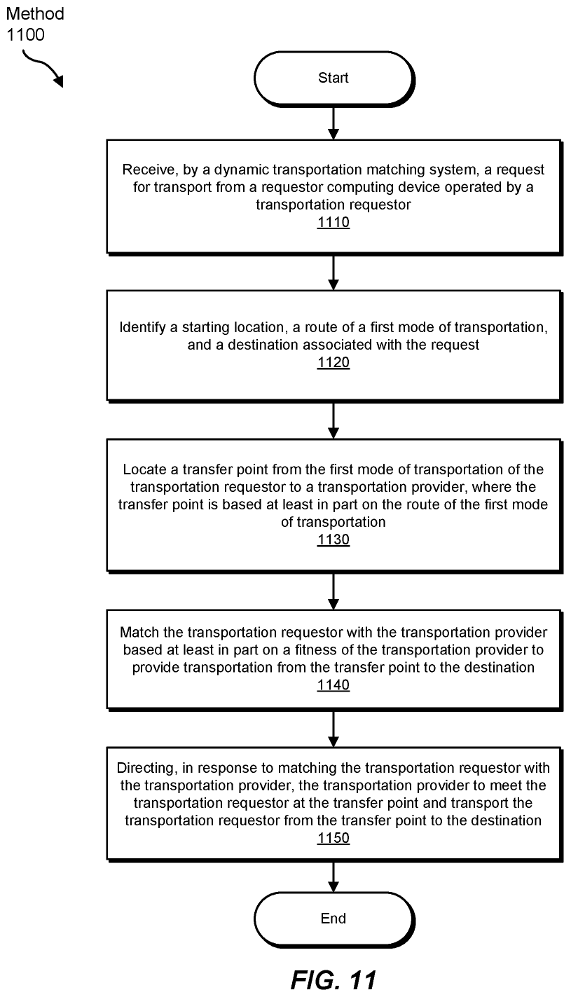

FIG. 11 illustrates an example method 1100 for dynamic transfer-based transportation. As illustrated in FIG. 11, at step 1110, one or more of the systems described herein may receive, by a dynamic transportation matching system, a request for transport from a requestor computing device operated by a transportation requestor.

In some examples, receiving the request from the transportation requestor may include receiving the request from the transportation requestor while the transportation requestor is en route to a destination via the first mode of transport. In some examples, receiving the request from the transportation requestor while the transportation requestor is en route to the destination via the first mode of transportation may include receiving periodic requests from the transportation requestor to locate the transfer point from the first mode of transportation to the transportation provider.

In some examples, receiving the request from the transportation requestor may include determining that the transportation requestor has previously specified at least one condition under which to perform a transfer and determining that the condition under which to perform the transfer has been met. Additionally or alternatively, receiving the request may include receiving specifying at least one condition under which to perform a transfer and determining that the condition under which to perform the transfer has been met.

At step 1120, one or more of the systems described herein may identify a starting location, a route of a first mode of transportation, and a destination associated with the request.

In one example, the first mode of transportation may include an additional transportation provider that is associated with the dynamic transportation network. In another example, the first mode of transportation may include an additional transportation provider that is not associated with in the dynamic transportation network.

At step 1130, one or more of the systems described herein may locate a transfer point from the first mode of transportation of the transportation requestor to a transportation provider that is associated with in a dynamic transportation network that is managed by the dynamic transportation matching system, wherein the transfer point is based at least in part on the route of the first mode of transportation.

In some examples, locating the transfer point may include determining a safety rating of the transfer point and/or an amenity of the transfer point and locating the transfer point based at least in part on the safety rating of the transfer point and/or the amenity of the transfer point. In some embodiments, determining the safety rating of the transfer point may include retrieving safety data from at least one safety data database.

In one embodiment, the transfer point may include a first location at which the transportation requestor exits the first mode of transportation and a second location that is within a calculated distance of the first location and at which the transportation requestor meets the transportation provider.

In some examples, locating the transfer point from the first mode of transportation of the transportation requestor to the transportation provider may include selecting the transportation provider based at least in part on a constraint of the transportation provider. For example, the constraint of the transportation provider may include a defined geographic area that an operator of the transportation provider has indicated a preference for the transportation provider remaining within. In some examples, the constraint of the transportation provider may include a number of seats of the transportation provider.

In some examples, locating the transfer point may include dynamically locating a transfer point based at least in part on a nearness of the transfer point to at least one of the transportation provider and the route of the first mode of transportation. In some examples, locating the transfer point from the first mode of transportation of the transportation requestor to the transportation provider may include locating the transfer point and the transportation provider that reduce travel time for the transportation requestor to the destination. Additionally or alternatively, locating the transfer point from the first mode of transportation of the transportation requestor to the transportation provider may include locating a transportation provider that is transporting an additional transportation requestor with a destination that is compatible with the destination of the transportation requestor.

At step 1140, one or more of the systems described herein may match the transportation requestor with the transportation provider based at least in part on a fitness of the transportation provider to provide transportation from the transfer point to the destination.

In some examples, matching the transportation requestor with the transportation provider based at least in part on the fitness of the transportation provider to provide transportation from the transfer point to the destination may include dynamically allocating a portion of the dynamic transportation network to provision a portion of a trip from the starting location of the transportation requestor to the destination of the transportation requestor.

At step 1150, one or more of the systems described herein may fulfill the request from the transportation requestor by directing the transportation provider to meet the transportation requestor at the transfer point and transport the transportation requestor from the transfer point to the destination.

In some examples, fulfilling the request from the transportation requestor may include directing the transportation requestor to meet the transportation provider at the transfer point. According to some examples, the method may further include locating an additional transfer point from the transportation provider to an additional mode of transportation with an additional route that may include an ultimate destination of the transportation requestor.

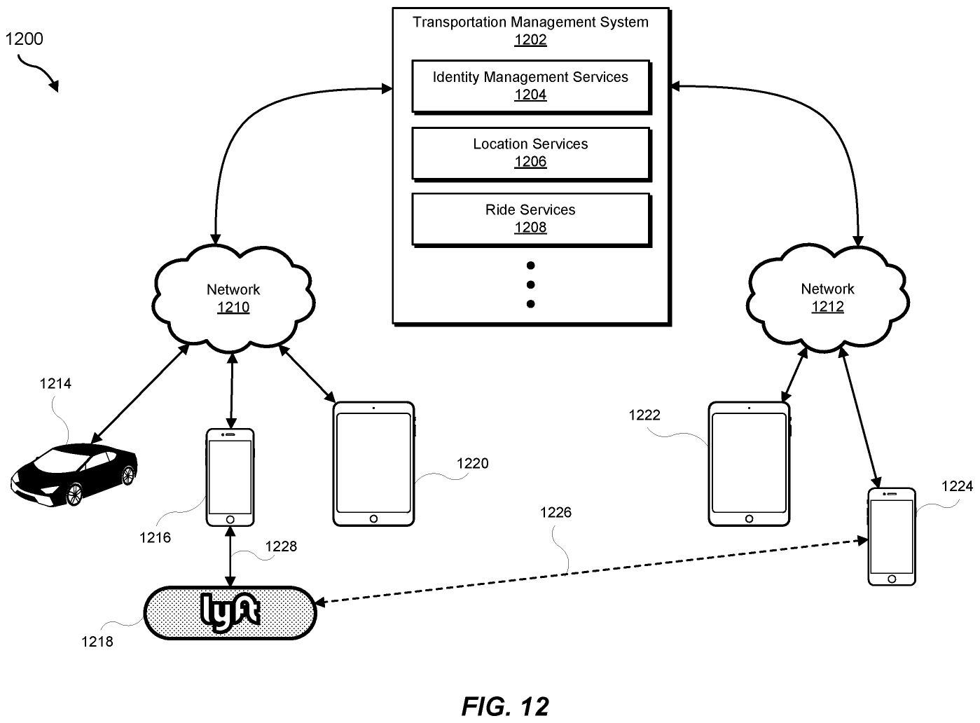

FIG. 12 shows a transportation management environment 1200, in accordance with various embodiments. As shown in FIG. 12, a transportation management system 1202 may run one or more services and/or software applications, including identity management services 1204, location services 1206, ride services 1208, and/or other services. Although FIG. 12 shows a certain number of services provided by transportation management system 1202, more or fewer services may be provided in various implementations. In addition, although FIG. 12 shows these services as being provided by transportation management system 1202, all or a portion of any of the services may be processed in a distributed fashion. For example, computations associated with a service task may be performed by a combination of transportation management system 1202 (including any number of servers, databases, etc.), one or more devices associated with a provider (e.g., devices integrated with managed vehicles 1214, provider's computing devices 1216 and tablets 1220, and transportation management vehicle devices 1218), and/or more or more devices associated with a ride requestor (e.g., the requestor's computing devices 1224 and tablets 1222). In some embodiments, transportation management system 1202 may include one or more general purpose computers, server computers, clustered computing systems, cloud-based computing systems, and/or any other computing systems or arrangements of computing systems. Transportation management system 1202 may be configured to run any or all of the services and/or software components described herein. In some embodiments, the transportation management system 1202 may include an appropriate operating system and/or various server applications, such as web servers capable of handling hypertext transport protocol (HTTP) requests, file transfer protocol (FTP) servers, database servers, etc.

In some embodiments, identity management services 1204 may be configured to perform authorization services for requestors and providers and/or manage their interactions and/or data with transportation management system 1202. This may include, e.g., authenticating the identity of providers and determining that they are authorized to provide services through transportation management system 1202. Similarly, requestors' identities may be authenticated to determine whether they are authorized to receive the requested services through transportation management system 1202. Identity management services 1204 may also manage and/or control access to provider and/or requestor data maintained by transportation management system 1202, such as driving and/or ride histories, vehicle data, personal data, preferences, usage patterns as a ride provider and/or as a ride requestor, profile pictures, linked third-party accounts (e.g., credentials for music and/or entertainment services, social-networking systems, calendar systems, task-management systems, etc.) and any other associated information. Transportation management system 1202 may also manage and/or control access to provider and/or requestor data stored with and/or obtained from third-party systems. For example, a requester or provider may grant transportation management system 1202 access to a third-party email, calendar, or task management system (e.g., via the user's credentials). As another example, a requestor or provider may grant, through a mobile device (e.g., 1216, 1220, 1222, or 1224), a transportation application associated with transportation management system 1202 access to data provided by other applications installed on the mobile device. In some examples, such data may be processed on the client and/or uploaded to transportation management system 1202 for processing.

In some embodiments, transportation management system 1202 may provide ride services 1208, which may include ride matching and/or management services to connect a requestor to a provider. For example, after identity management services module 1204 has authenticated the identity a ride requestor, ride services module 1208 may attempt to match the requestor with one or more ride providers. In some embodiments, ride services module 1208 may identify an appropriate provider using location data obtained from location services module 1206. Ride services module 1208 may use the location data to identify providers who are geographically close to the requestor (e.g., within a certain threshold distance or travel time) and/or who are otherwise a good match with the requestor. Ride services module 1208 may implement matching algorithms that score providers based on, e.g., preferences of providers and requestors; vehicle features, amenities, condition, and/or status; providers' preferred general travel direction and/or route, range of travel, and/or availability; requestors' origination and destination locations, time constraints, and/or vehicle feature needs; and any other pertinent information for matching requestors with providers. In some embodiments, ride services module 1208 may use rule-based algorithms and/or machine-learning models for matching requestors and providers.

Transportation management system 1202 may communicatively connect to various devices through networks 1210 and/or 1212. Networks 1210 and 1212 may include any combination of interconnected networks configured to send and/or receive data communications using various communication protocols and transmission technologies. In some embodiments, networks 1210 and/or 1212 may include local area networks (LANs), wide-area networks (WANs), and/or the Internet, and may support communication protocols such as transmission control protocol/Internet protocol (TCP/IP), Internet packet exchange (IPX), systems network architecture (SNA), and/or any other suitable network protocols. In some embodiments, data may be transmitted through networks 1210 and/or 1212 using a mobile network (such as a mobile telephone network, cellular network, satellite network, or other mobile network), a public switched telephone network (PSTN), wired communication protocols (e.g., Universal Serial Bus (USB), Controller Area Network (CAN)), and/or wireless communication protocols (e.g., wireless LAN (WLAN) technologies implementing the IEEE 802.12 family of standards, Bluetooth, Bluetooth Low Energy, Near Field Communication (NFC), Z-Wave, and ZigBee). In various embodiments, networks 1210 and/or 1212 may include any combination of networks described herein or any other type of network capable of facilitating communication across networks 1210 and/or 1212.

In some embodiments, transportation management vehicle device 1218 may include a provider communication device configured to communicate with users, such as drivers, passengers, pedestrians, and/or other users. In some embodiments, transportation management vehicle device 1218 may communicate directly with transportation management system 1202 or through another provider computing device, such as provider computing device 1216. In some embodiments, a requestor computing device (e.g., device 1224) may communicate via a connection 1226 directly with transportation management vehicle device 1218 via a communication channel and/or connection, such as a peer-to-peer connection, Bluetooth connection, NFC connection, ad hoc wireless network, and/or any other communication channel or connection. Although FIG. 12 shows particular devices communicating with transportation management system 1202 over networks 1210 and 1212, in various embodiments, transportation management system 1202 may expose an interface, such as an application programming interface (API) or service provider interface (SPI) to enable various third parties which may serve as an intermediary between end users and transportation management system 1202.

In some embodiments, devices within a vehicle may be interconnected. For example, any combination of the following may be communicatively connected: vehicle 1214, provider computing device 1216, provider tablet 1220, transportation management vehicle device 1218, requestor computing device 1224, requestor tablet 1222, and any other device (e.g., smart watch, smart tags, etc.). For example, transportation management vehicle device 1218 may be communicatively connected to provider computing device 1216 and/or requestor computing device 1224. Transportation management vehicle device 1218 may establish communicative connections, such as connections 1226 and 1228, to those devices via any suitable communication technology, including, e.g., WLAN technologies implementing the IEEE 802.12 family of standards, Bluetooth, Bluetooth Low Energy, NFC, Z-Wave, ZigBee, and any other suitable short-range wireless communication technology.

In some embodiments, users may utilize and interface with one or more services provided by the transportation management system 1202 using applications executing on their respective computing devices (e.g., 1216, 1218, 1220, and/or a computing device integrated within vehicle 1214), which may include mobile devices (e.g., an iPhone®, an iPad®, mobile telephone, tablet computer, a personal digital assistant (PDA)), laptops, wearable devices (e.g., smart watch, smart glasses, head mounted displays, etc.), thin client devices, gaming consoles, and any other computing devices. In some embodiments, vehicle 1214 may include a vehicle-integrated computing device, such as a vehicle navigation system, or other computing device integrated with the vehicle itself, such as the management system of an autonomous vehicle. The computing device may run on any suitable operating systems, such as Android®, iOS®, macOS®, Windows®, Linux®, UNIX®, or UNIX®-based or Linux®-based operating systems, or other operating systems. The computing device may further be configured to send and receive data over the Internet, short message service (SMS), email, and various other messaging applications and/or communication protocols. In some embodiments, one or more software applications may be installed on the computing device of a provider or requestor, including an application associated with transportation management system 1202. The transportation application may, for example, be distributed by an entity associated with the transportation management system via any distribution channel, such as an online source from which applications may be downloaded. Additional third-party applications unassociated with the transportation management system may also be installed on the computing device. In some embodiments, the transportation application may communicate or share data and resources with one or more of the installed third-party applications.

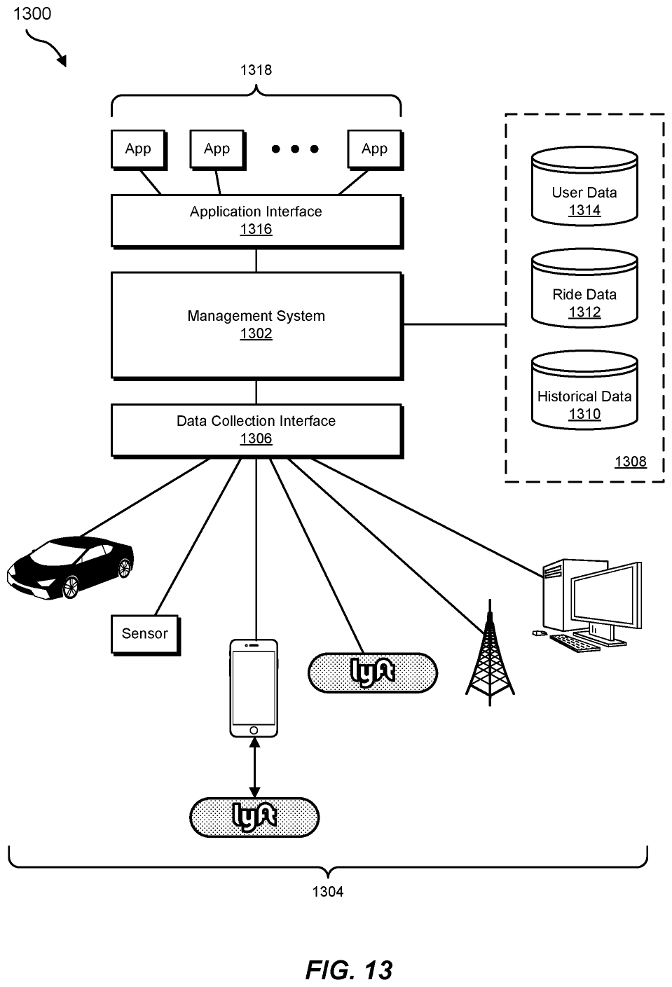

FIG. 13 shows a data collection and application management environment 1300, in accordance with various embodiments. As shown in FIG. 13, management system 1302 may be configured to collect data from various data collection devices 1304 through a data collection interface 1306. As discussed above, management system 1302 may include one or more computers and/or servers or any combination thereof. Data collection devices 1304 may include, but are not limited to, user devices (including provider and requestor computing devices, such as those discussed above), provider communication devices, laptop or desktop computers, vehicle data (e.g., from sensors integrated into or otherwise connected to vehicles), ground-based or satellite-based sources (e.g., location data, traffic data, weather data, etc.), or other sensor data (e.g., roadway embedded sensors, traffic sensors, etc.). Data collection interface 1306 can include, e.g., an extensible device framework configured to support interfaces for each data collection device. In various embodiments, data collection interface 1306 may be extended to support new data collection devices as they are released and/or to update existing interfaces to support changes to existing data collection devices. In various embodiments, data collection devices may communicate with data collection interface 1306 over one or more networks. The networks may include any network or communication protocol as would be recognized by one of ordinary skill in the art, including those networks discussed above.

As shown in FIG. 13, data received from data collection devices 1304 can be stored in data store 1308. Data store 1308 may include one or more data stores, such as databases, object storage systems and services, cloud-based storage services, and other data stores. For example, various data stores may be implemented on a non-transitory storage medium accessible to management system 1302, such as historical data store 1310, ride data store 1312, and user data store 1314. Data stores 1308 can be local to management system 1302, or remote and accessible over a network, such as those networks discussed above or a storage-area network or other networked storage system. In various embodiments, historical data 1310 may include historical traffic data, weather data, request data, road condition data, or any other data for a given region or regions received from various data collection devices. Ride data 1312 may include route data, request data, timing data, and other ride related data, in aggregate and/or by requestor or provider. User data 1314 may include user account data, preferences, location history, and other user-specific data. Although certain data stores are shown by way of example, any data collected and/or stored according to the various embodiments described herein may be stored in data stores 1308.

As shown in FIG. 13, an application interface 1316 can be provided by management system 1302 to enable various apps 1318 to access data and/or services available through management system 1302. Apps 1318 may run on various user devices (including provider and requestor computing devices, such as those discussed above) and/or may include cloud-based or other distributed apps configured to run across various devices (e.g., computers, servers, or combinations thereof). Apps 1318 may include, e.g., aggregation and/or reporting apps which may utilize data 1308 to provide various services (e.g., third-party ride request and management apps). In various embodiments, application interface 1316 can include an API and/or SPI enabling third party development of apps 1318. In some embodiments, application interface 1316 may include a web interface, enabling web-based access to data 1308 and/or services provided by management system 1302. In various embodiments, apps 1318 may run on devices configured to communicate with application interface 1316 over one or more networks. The networks may include any network or communication protocol as would be recognized by one of ordinary skill in the art, including those networks discussed above, in accordance with an embodiment of the present disclosure.

While various embodiments of the present disclosure are described in terms of a ridesharing service in which the ride providers are human drivers operating their own vehicles, in other embodiments, the techniques described herein may also be used in environments in which ride requests are fulfilled using autonomous vehicles. For example, a transportation management system of a ridesharing service may facilitate the fulfillment of ride requests using both human drivers and autonomous vehicles.

As detailed above, the computing devices and systems described and/or illustrated herein broadly represent any type or form of computing device or system capable of executing computer-readable instructions, such as those contained within the modules described herein. In their most basic configuration, these computing device(s) may each include at least one memory device and at least one physical processor.

In some examples, the term “memory device” generally refers to any type or form of volatile or non-volatile storage device or medium capable of storing data and/or computer-readable instructions. In one example, a memory device may store, load, and/or maintain one or more of the modules described herein. Examples of memory devices include, without limitation, Random Access Memory (RAM), Read Only Memory (ROM), flash memory, Hard Disk Drives (HDDs), Solid-State Drives (SSDs), optical disk drives, caches, variations or combinations of one or more of the same, or any other suitable storage memory.

In some examples, the term “physical processor” generally refers to any type or form of hardware-implemented processing unit capable of interpreting and/or executing computer-readable instructions. In one example, a physical processor may access and/or modify one or more modules stored in the above-described memory device. Examples of physical processors include, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, or any other suitable physical processor.

Although illustrated as separate elements, the modules described and/or illustrated herein may represent portions of a single module or application. In addition, in certain embodiments one or more of these modules may represent one or more software applications or programs that, when executed by a computing device, may cause the computing device to perform one or more tasks. For example, one or more of the modules described and/or illustrated herein may represent modules stored and configured to run on one or more of the computing devices or systems described and/or illustrated herein. One or more of these modules may also represent all or portions of one or more special-purpose computers configured to perform one or more tasks.

In addition, one or more of the modules described herein may transform data, physical devices, and/or representations of physical devices from one form to another. Additionally or alternatively, one or more of the modules recited herein may transform a processor, volatile memory, non-volatile memory, and/or any other portion of a physical computing device from one form to another by executing on the computing device, storing data on the computing device, and/or otherwise interacting with the computing device.

In some embodiments, the term “computer-readable medium” generally refers to any form of device, carrier, or medium capable of storing or carrying computer-readable instructions. Examples of computer-readable media include, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the instant disclosure. The embodiments disclosed herein should be considered in all respects illustrative and not restrictive. Reference should be made to the appended claims and their equivalents in determining the scope of the instant disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

What is claimed is:

1. A computer-implemented method comprising:
receiving, by a dynamic transportation matching system, a request for transport from a requestor computing device operated by a transportation requestor;
identifying a starting location, a route of a first mode of transportation, and a destination associated with the request;
locating a transfer point from the first mode of transportation of the transportation requestor to a transportation provider, wherein the transfer point is based at least in part on the route of the first mode of transportation;
matching the transportation requestor with the transportation provider based at least in part on a fitness of the transportation provider to provide transportation from the transfer point to the destination; and
directing, in response to matching the transportation requestor with the transportation provider, the transportation provider to meet the transportation requestor at the transfer point and transport the transportation requestor from the transfer point to the destination.

2. The computer-implemented method of claim 1, wherein receiving the request from the requestor computing device comprises receiving the request from the requestor computing device while the transportation requestor is en route to a destination via the first mode of transport.

3. The computer-implemented method of claim 2, wherein locating the transfer point comprises periodically performing calculations to locate the transfer point from the first mode of transportation to the transportation provider.

4. The computer-implemented method of claim 1, wherein locating the transfer point comprises:
calculating a plurality of estimated times to the destination wherein each estimated time to the destination is associated with a potential transfer point within a plurality of potential transfer points that are identified based at least in part on the route of the first mode of transportation; and
selecting the transfer point from the plurality of potential transfer points based at least in part on the estimated time to the destination calculated for the transfer point.

5. The computer-implemented method of claim 1, wherein the transfer point comprises a first location at which the transportation requestor exits the first mode of transportation and a second location that is within a calculated distance of the first location and at which the transportation requestor meets the transportation provider.

6. The computer-implemented method of claim 1, wherein locating the transfer point comprises:
determining at least one of a safety rating of the transfer point and an amenity of the transfer point; and
locating the transfer point based at least in part on at least one of the safety rating of the transfer point and the amenity of the transfer point.

7. The computer-implemented method of claim 6, wherein determining the safety rating of the transfer point comprises retrieving safety data from at least one safety data database.

8. The computer-implemented method of claim 1, wherein locating the transfer point from the first mode of transportation of the transportation requestor to the transportation provider comprises selecting the transportation provider based at least in part on a constraint of the transportation provider.

9. The computer-implemented method of claim 8, wherein the constraint of the transportation provider comprises a defined geographic area that an operator of the transportation provider has indicated a preference for the transportation provider remaining within.

10. The computer-implemented method of claim 8, wherein the constraint of the transportation provider comprises a number of seats of the transportation provider.

11. The computer-implemented method of claim 1, wherein locating the transfer point comprises dynamically locating a transfer point based at least in part on a nearness of the transfer point to at least one of a current location of the transportation provider and the route of the first mode of transportation.

12. The computer-implemented method of claim 1, wherein receiving the request from the transportation requestor comprises:
receiving a request from the transportation requestor specifying at least one condition under which to perform a transfer; and
determining that the condition under which to perform the transfer has been met.

13. The computer-implemented method of claim 1, wherein locating the transfer point from the first mode of transportation of the transportation requestor to the transportation provider comprises locating the transfer point and the transportation provider that reduce travel time for the transportation requestor to the destination.

14. The computer-implemented method of claim 1, wherein locating the transfer point from the first mode of transportation of the transportation requestor to the transportation provider comprises locating a transportation provider that is transporting an additional transportation requestor with a destination that is compatible with the destination of the transportation requestor.

15. The computer-implemented method of claim 1, further comprising locating an additional transfer point from the transportation provider to an additional mode of transportation with an additional route that comprises an ultimate destination of the transportation requestor.

16. The computer-implemented method of claim 1, wherein:
the first mode of transportation comprises an additional transportation provider; and
the transportation provider and the additional transportation provider are associated with a dynamic transportation network managed by the dynamic transportation matching system.

17. The computer-implemented method of claim 1, wherein the first mode of transportation comprises an additional transportation provider that is not associated with the dynamic transportation network.

18. The computer-implemented method of claim 1, wherein fulfilling the request from the transportation requestor comprises directing, via the requestor computing device, the transportation requestor to meet the transportation provider at the transfer point.

19. A system comprising one or more physical processors and one or more memories coupled to one or more of the physical processors, the one or more memories comprising instructions operable when executed by the one or more physical processors to cause the system to perform operations comprising:
receiving, by a dynamic transportation matching system, a request for transport from a requestor computing device operated by a transportation requestor;
identifying a starting location, a route of a first mode of transportation, and a destination associated with the request;
locating a transfer point from the first mode of transportation of the transportation requestor to a transportation provider, wherein the transfer point is based at least in part on the route of the first mode of transportation;
matching the transportation requestor with the transportation provider based at least in part on a fitness of the transportation provider to provide transportation from the transfer point to the destination; and
directing, in response to matching the transportation requestor with the transportation provider, the transportation provider to meet the transportation requestor at the transfer point and transport the transportation requestor from the transfer point to the destination.

20. A non-transitory computer-readable storage medium comprising computer-readable instructions that, when executed by at least one processor of a computing device, cause the computing device to:
receive, by a dynamic transportation matching system, a request for transport from a requestor computing device operated by a transportation requestor;
identify a starting location, a route of a first mode of transportation, and a destination associated with the request;
locate a transfer point from the first mode of transportation of the transportation requestor to a transportation provider, wherein the transfer point is based at least in part on the route of the first mode of transportation;
match the transportation requestor with the transportation provider based at least in part on a fitness of the transportation provider to provide transportation from the transfer point to the destination; and
direct, in response to matching the transportation requestor with the transportation provider, the transportation provider to meet the transportation requestor at the transfer point and transport the transportation requestor from the transfer point to the destination.
